(19) United States
(12) Patent Application Publication
(10) Pub. No.: US 2010/0220497 A1
(43) Pub. Date: Sep. 2, 2010

(54) LUMINAIRE HAVING FLOATING LUMINOUS LIGHT SOURCE

(76) Inventor: Peter Y.Y. Ngai, Alamo, CA (US)

Correspondence Address: BEESON SKINNER BEVERLY, LLP, ONE KAISER PLAZA, SUITE 750, OAKLAND, CA, 94612, US

(21) Appl. No.: 12/687,848

(22) Filed: Jan. 14, 2010

Related U.S. Application Data
(60) Provisional application No. 61/144,710, filed on Jan. 14, 2009.

(51) Int. Cl. F21V 7/04

(52) U.S. Cl. 362/610; 362/612

(57) ABSTRACT

A luminaire 31 has a transparent light waveguide 33, which includes a perimeter edge 41, 43, at least one light feed edge portion 41 along its perimeter edge, a visible surface 34, and light extracting means 38. A support structure 49 supports the light waveguide along at least a portion of its perimeter edge, and a light source, such as LEDs 45, is provided for introducing light into the light feed edge portion of the waveguide. Light is extracted from only a portion of the waveguide by the light extracting means. The light extracting means produces one or more luminous areas on a portion of the visible surface of the waveguide, and are positioned on the waveguide such that the luminous area or areas produced thereby give the appearance of a source of light for the luminaire that is substantially detached from the luminaire's support structure.

### BACKGROUND OF THE INVENTION

The present invention generally relates to luminaires, and more particularly to luminaires having a source of light that is observable at normal viewing angles within a space. The invention has particular application in architectural lighting, where luminaires contribute to the surrounding architectural environment.

Architectural lighting fixtures having observable sources of light are well known. The observable sources of light are provided by exposed lamps and/or luminous areas on shielding elements or optical elements used for light controls, such as lenses, diffusers and reflectors. Architectural lighting fixtures are integrated into the architectural space using various mounting and suspension schemes, and include recessed lighting and wall-mounted, furniture-mounted, and ceiling-suspended fixtures.

In creating a lighting environment for an architectural space, lighting designers have many tools available to them for designing lighting fixtures that control the distribution of light within the space and the visible brightness of the exposed luminous surfaces of the fixtures. However, heretofore, the lighting designer has been limited in his or her ability to readily control the location of the luminous surfaces on architectural lighting fixtures in relation to the surrounding structure of the fixture, and to create light-producing luminous elements on a fixture that are visually separated from the structural components of the fixture. The present invention overcomes such limitations, and provides lighting designers the ability to create light-producing luminous surfaces on the luminaire in a wide variety of surface patterns that complement or provide visual accents to or within the surrounding architectural environment.

### SUMMARY OF THE INVENTION

The present invention is directed to a luminaire having a planar light waveguide with opposed planar surfaces, which produces a visible and seemingly floating source of light for illuminating a space. The visible source of light appears as one or more discrete luminous areas on the visible planar surface or surfaces of the light waveguide, which is otherwise transparent. Light is fed into the luminaire's transparent light waveguide from an edge or edges of the transparent waveguide by light sources, which are preferably LEDs or equivalent small sources of light. The light introduced into the edge of the guide is extracted through one or both guide surfaces at desired locations and in desired patterns to produce discrete luminous areas on the guide, which are unconnected or predominately unconnected to the luminaire's support structure. Support structures for the luminaire can include any structure that permits the luminaire to be surface-mounted, recessed into a surface, suspended below a surface, or supported above a surface or a piece of furniture.

The light waveguide of the luminaire of the invention is supported by a support structure along at least a portion of its perimeter edge. Light extraction from the waveguide can be achieved by applying a thin diffuser film affixed, suitably by optical bonding, to either the bottom or top surfaces of the light waveguide, or to both. However, other light extraction techniques could be used, such as microprisms on the extraction surfaces of the guide. Light extraction could additionally be achieved using a combination of diffuser films and prisms. The light extraction means will create at least one light-extracting portion of the light waveguide that in turn produces at least one discrete luminous area on a visible planar surface of the guide. In the regions of the waveguide where there is no light extraction, the waveguide is non-luminous and transparent. The non-luminous, transparent regions of the waveguide bound the one or more discrete luminous areas on the guide's visible surface or surfaces, creating the appearance of a floating source or sources of light. More than one waveguide could be supported by the support structure, each producing at least one discrete luminous area on a visible planar surface of the guide.

### DESCRIPTION OF THE DRAWINGS

FIG. 1 is a graphical illustration of a light waveguide illustrating the principles of the light waveguide.

FIG. 2 is a graphical illustration of the light waveguide shown in FIG. 1 with light extraction means provided in the form of a diffuser film adhered to one of the planar surfaces of the waveguide.

FIG. 3 is a graphical illustration of another light waveguide having a light extracting portion wherein the light extraction is bidirectional, that is, light is extracted through both planar surfaces of the waveguide.

FIG. 4 is a graphical illustration of an example of one configuration for the light feed edge of a light waveguide as used in the invention.

FIG. 5 is a graphical illustration of another possible edge configuration for the light feed edge of a light waveguide as used in the invention.

FIG. 6 is a bottom perspective view of an example of a waveguide luminaire in accordance with the invention.

FIG. 7 is a bottom-plan view of a portion thereof.

FIG. 8 is a cross-sectional view thereof, taken along lines 8-8 in FIG. 7.

FIG. 9 is a graphical illustration of a further embodiment of the waveguide luminaire in accordance with the invention wherein light extraction occurs at multiple locations on the light waveguide for producing multiple luminous areas.

FIGS. 10-13 show yet further embodiments of the invention, which include different perimeter shapes, and different shapes and configurations for the light extracting portions of the luminaire.

FIGS. 14 and 15 graphically illustrate still other embodiments of the invention, wherein the luminaire waveguides are supported by a center support structure and light extraction is achieved by light-shaping diffusers.

FIG. 16 is a top perspective view of another embodiment of the invention wherein the luminaire waveguide lies in a flat plane.

FIG. 17 is a partially exploded, cut-away view thereof, except that the light-extracting portion of the waveguide is not illustrated in this view.

FIG. 18 is a cross-sectional view of one of the support rails of the luminaire shown in FIGS. 16 and 17.

FIGS. 19-23 are graphical depictions of various possible implementations of a luminaire in accordance with the invention.

### DESCRIPTION OF THE ILLUSTRATED EMBODIMENTS

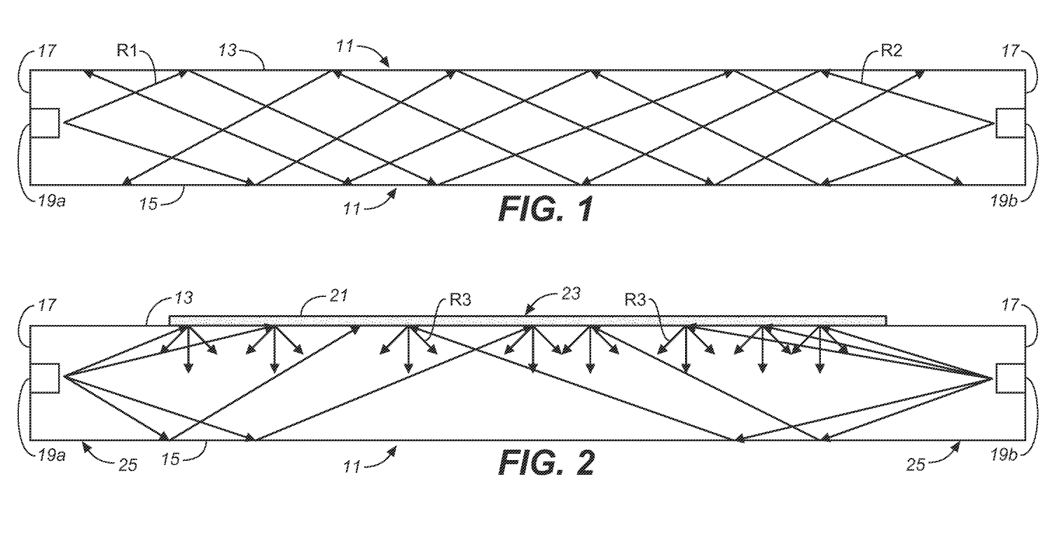

Light waveguides, also sometimes referred to as “light guides” or “light pipes,” work on the principle of internal reflections governed by Snell's Law. Light introduced at the edges of the guide is internally reflected or “piped” down the guide without emerging from the guide's surfaces, unless and until it is somehow extracted from the guide. This principle is illustrated in FIG. 1, wherein a light waveguide 11, fabricated of a clear, light-transmitting material, has parallel top and bottom surfaces 13, 15 and edges 17 through which light can be introduced into the guide. In the illustrated waveguide, light is introduced into each of the guide's edges 17 by means of light sources 19a, 19b, suitably LEDs, that are shown as being inset into the guide. The light produced by these sources is piped down the guide, as represented by light rays R1 with respect to source 19a, and light rays R2 with respect to source 19b. Because of the low angle of incidence of light rays R1 and R2 on surfaces 13, 15 of the waveguide, the light rays will internally reflect off of these surfaces, and consequently will not escape from the guide.

FIG. 2 illustrates the waveguide shown in FIG. 1 with the addition of a means for extracting light from the waveguide that has been introduced into the waveguide 11 by light sources 19a, 19b. In the case of the light guide shown in FIG. 2, the top surface 13 of the guide is provided with a layer of a light-diffusing reflective material 21, which is preferably optically bonded to this surface. Such a layer could be provided, for example, in the form of highly reflective diffuse paint. (Other possible means of providing light extraction are mentioned below.) The optically bonded layer 21 acts as an “extractor” for the light piped from the edges 17 of the guide by the change in the internal reflections from surface 13 where the diffuse material has been applied. The reflections are now diffuse in nature, resulting in reflected light being scattered toward the opposite surface 15 of the guide, as represented by light rays R3. The scattered light that strikes the opposite surface 15 at high angles of incidence (closer to the perpendicular) will emerge from the opposite surface, causing the area of the surface opposite the diffuser layer to emit light and become luminous. This luminous area of the waveguide will correspond in position and outline to the position and outline of the light-extracting diffusing material applied to the top waveguide surface 13. Where the diffusing material does not cover the entire top surface of the guide, there will portions of the waveguide beyond the light extractor (denoted by the numeral 25) that will not emit light and will appear non-luminous and transparent to an observer viewing the waveguide.

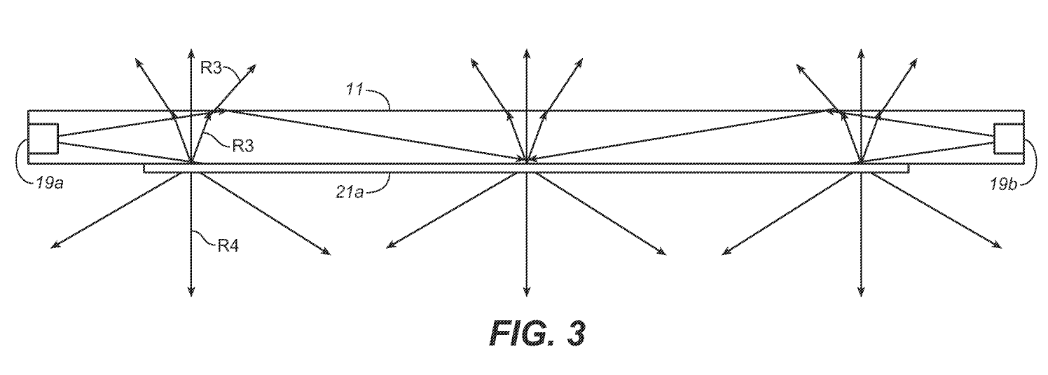

FIG. 3 illustrates a light waveguide 11 having a bi-directional light extractor 21a, that is, a light extractor that is not totally reflective but which allows the light to be scattered in two directions, as represented by light ray arrows R3 and R4. In this case, light emerges from both the top and bottom surfaces of the waveguide in the region of the light extractor. On the guide's bottom surface, a luminous area or pattern will appear that corresponds in location and shape to the location and shape of the light extractor. This pattern will be created by the emerging light represented by light ray arrows R4. Light will not emerge, and the bottom waveguide surfaces will not appear luminous beyond where the light extractor is not present.

It is noted that the bi-directional light extractor 21a could be applied to the top surface of the waveguide instead of the bottom surface to provide a similar luminous pattern on the bottom surface of the guide. If the light waveguide in FIG. 3 were turned upside down, this luminous pattern would be created by the emerging light rays R3.

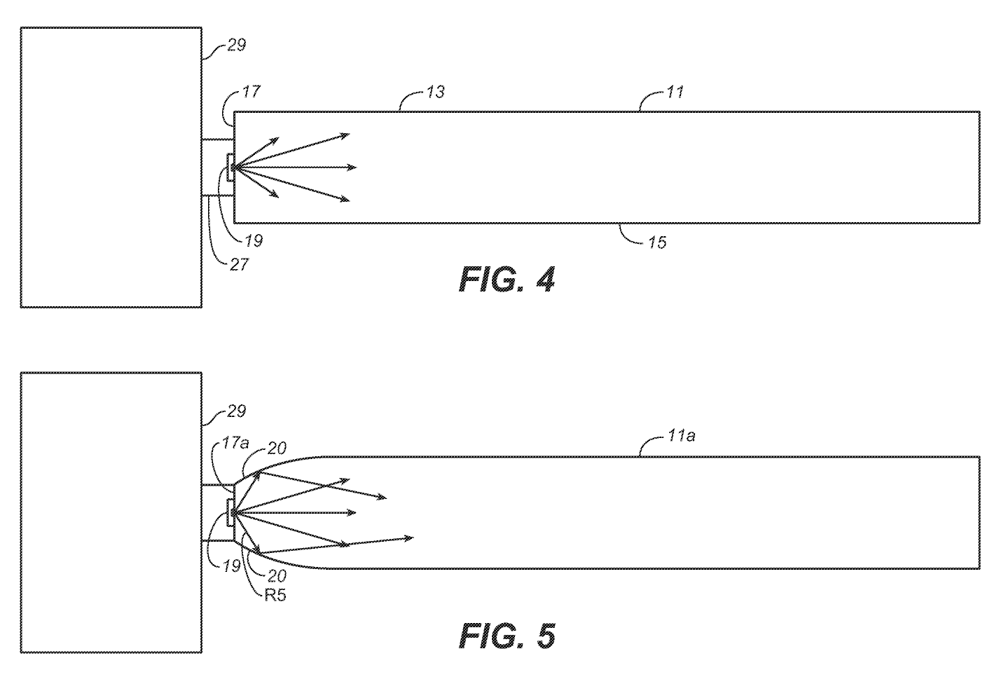

FIGS. 4 and 5 show examples of configurations that can be used for the light feed edge 17 of waveguide 11, illustrated in FIGS. 1-4. In FIG. 4, waveguide 11 terminates at a flat waveguide feed edge 17 that is perpendicular to the opposed planar waveguide surfaces 13, 15. To improve the efficiency by which light from the source light is coupled into the waveguide, the light source 19 can be optically bonded to the waveguide edge. However, the light source could simply be positioned against the guide's feed edge. A reflective material, such as white reflective tape (not shown), can be applied to the waveguide edge 17 around the light sources to prevent light from escaping through these edges. For example, reflective tape could be applied to the waveguide edges having apertures for LED light sources distributed along the edge of the waveguide. A suitable heat-conductive backing or encapsulating structure 27 is suitably provided for the light sources. The waveguide edge can in turn be supported by a suitable support structure, represented by block 29, which depends on the design of the luminaire, and which preferably is capable of dissipating heat from the light source.

In FIG. 5, the edge portion of waveguide 11a is curved toward the center line of the waveguide to reduce the area of the light feed edge 17a, and to provide upper and lower curved surfaces 20 adjacent the feed edge of the guide, which will internally reflect high angle light emitted from the light source 19, as represented by light rays R5. The tapered edge configuration shown in FIG. 5 will minimize the amount of light escaping from the edge of the waveguide.

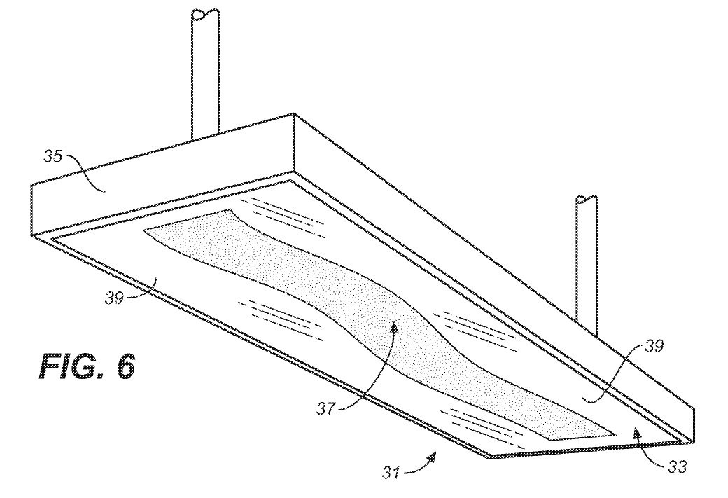

FIGS. 6-8 illustrate a first example of a waveguide luminaire for providing a floating light source in accordance with the invention. FIG. 6 shows the overall construction of a ceiling suspended luminaire 31 having a bottom panel in the form of a planar, transparent waveguide 33, and a perimeter frame 35, which covers a support structure described below. The substantially transparent light waveguide 33 is provided with a light extraction means over a portion of the waveguide for extracting light through the bottom surface of the waveguide in an elongated wavy pattern, so as to produce a luminous area 37 on the bottom of the waveguide in the form of an elongated wavy band. When this luminaire is viewed from below, the elongated wavy luminous area 37 is seen as the source of the light from the luminaire. The waveguide regions 39 surrounding this luminous area are not luminous and are transparent, to give the appearance that the luminous area 37 is floating in space and detached from the luminaire's surrounding frame 35.

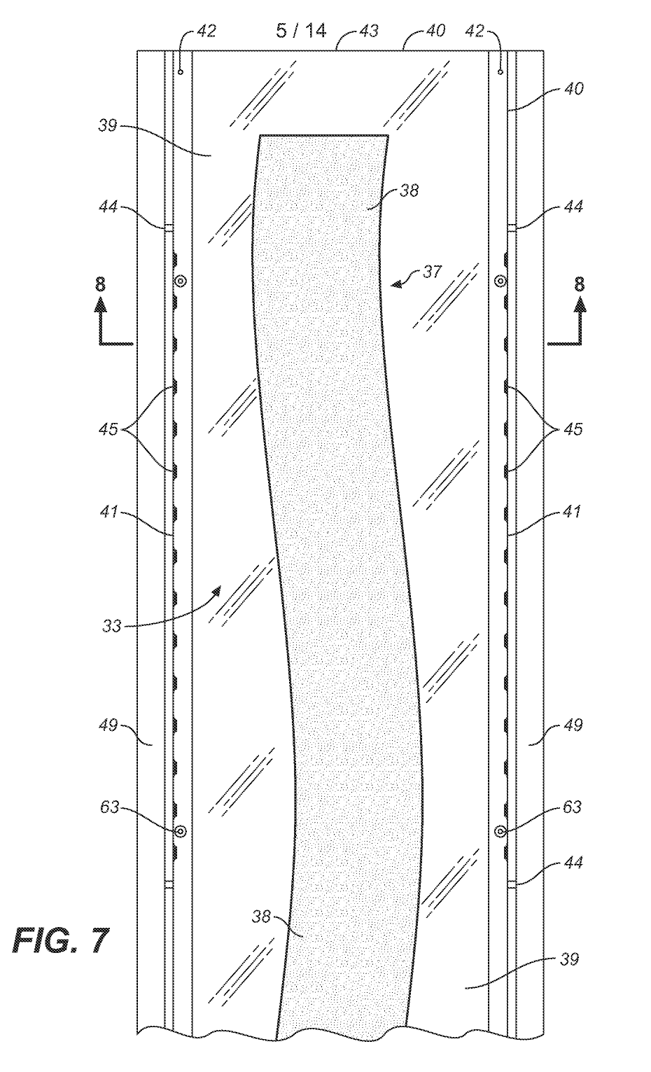

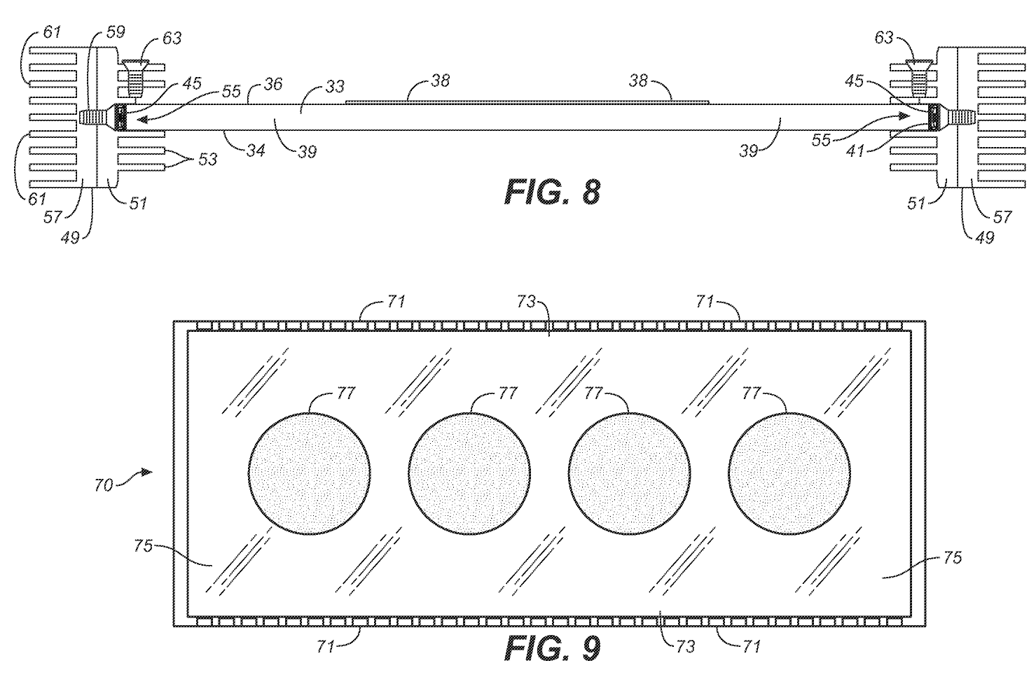

FIGS. 7 and 8 show the light waveguide and light source components of the luminaire seen in FIG. 6, as well as a heat-dissipating support structure for the luminaire waveguide. Referring to FIGS. 7 and 8, the elongated, rectangular light guide 33 has a perimeter edge 40 comprised of parallel long edges 41 and parallel short end edges 43. A strip of equally spaced LED light sources 45 are positioned in opposition to each other along each of the long edges 41 of the light guide. These opposed strips of LEDs introduce light into the opposed light feed edges of the guide such that the light is piped toward the guide's light extracting means. The result of the light extraction at the light extracting region of the waveguide is to produce the seemingly floating, wavy luminous band 37 on the visible underside of the luminaire.

As best shown in FIG. 8, the light extracting means for the light waveguide 33 of luminaire 11 can be created by applying a film or layer of diffusing material 38 to the top surface 36 of the light waveguide, opposite the visible planar surface 34 on the bottom of the guide. The light-diffusing material is applied in the form of a wavy band to produce a corresponding luminous area pattern 37 on the guide's bottom surface, as shown in FIGS. 6 and 7. The diffuser material 38 can be reflective for reflecting all of the extracted light in the wavy band pattern through the bottom of the luminaire, or it can be partially light transmissive, such that some of the extracted light is directed upwardly above the luminaire to produce a component of indirect lighting.

As best seen in FIG. 8, the elongated light feed edges 41 of the luminaire's light waveguide 33 are set into and supported by elongated heat conductive strip assemblies 49, which are suitably fabricated of extruded aluminum. The heat conductive strip assemblies each include an inner strip 51 having inwardly projecting heat fins 53 and a center channel 55 having a width corresponding to the thickness of the light waveguide. A second outer strip 57, attached to the inner strip by means of suitable fasteners such as screw fasteners 59, provide for further heat dissipation by means of outwardly extending heat fins 61.

To mount the luminaire's waveguide 33 to the heat conductive strip assemblies 49 shown in FIGS. 7 and 8, the LED strips 45 can be secured to the opposed longitudinal edges 41 of the waveguide. (To increase efficiency, the LED strips can be optically bonded to these waveguide edges.) With the LED strips in place, the strip assemblies 49 can be fitted onto the edges 41 of the waveguide by placing the edges of the waveguide into the center channels 55 of the strip assemblies. Once inserted, the edges can be firmly held in place by set screws 63. As best seen in FIG. 8, once the waveguide edges are secured in the strip assemblies, the LED strips 45 will be encased in the center channels of the strip assemblies between the bottom of these channels and the waveguide's longitudinal edges 41. Reflective tape can be applied to the short edges 43 of the waveguide to prevent light introduced into the waveguide by the strip of LEDs 45 from escaping through the ends of the waveguide. However, with the positioning of the LED strips in direct opposition to the light extractor band 38, minimal light loss would be expected through the short ends of the waveguide.

As seen in FIG. 7, the waveguide supporting strip assemblies 49 illustrated in FIGS. 7 and 8 can be provided with suitable wire holes 42 at the corners of the strip assemblies for attaching suspension wires to the strip assemblies. Additional wires in holes 44 can be provided in the strip assemblies for the lead wires for the LED strips 45.

Suitably, the thickness of the light waveguide 33 can be between about ⅛ of an inch and ½ of an inch. However, the use of waveguides having other thicknesses is possible depending on the size of the LED light sources used and the optics of the waveguide edge configuration and LED mounting. The material for the light waveguide should be a material that has a relatively high degree of transparency, such as clear acrylic, clear glass, or clear polycarbonate. A clear polycarbonate would provide a durable light waveguide that is resistant to breakage and scratching.

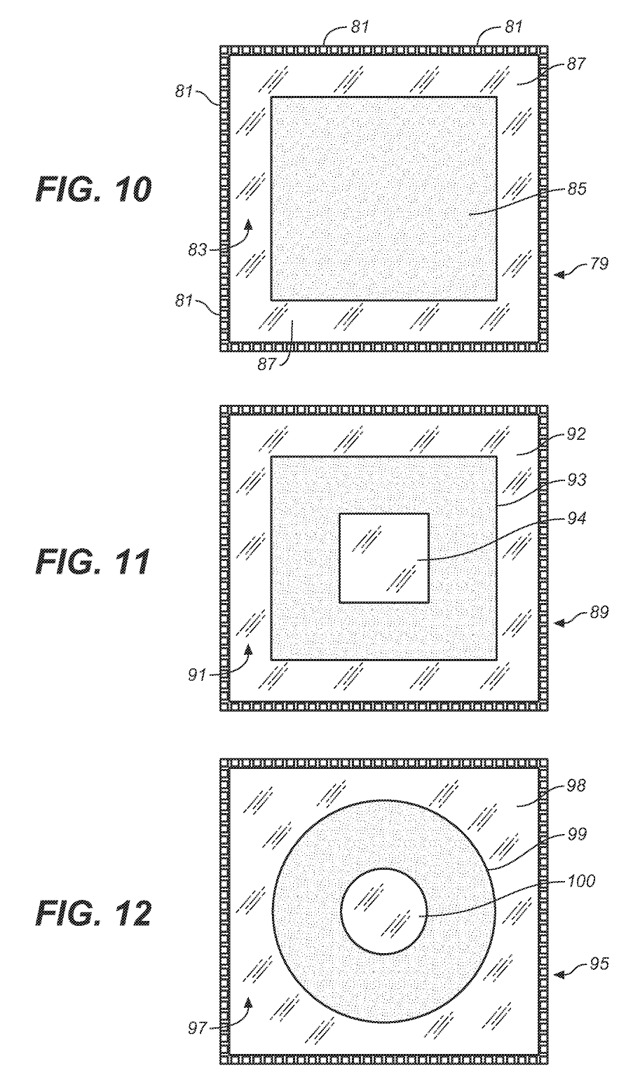

FIGS. 9-13 graphically illustrate examples of alternative configurations for a luminaire in accordance with the invention. In FIG. 9, a rectangular luminaire 70 has opposed strips of LEDs 71 configured along the elongated edges 73 of the luminaire's transparent waveguide 75. The light-extracting means on the waveguide are provided in the form of circular light-extracting portions 77 for producing a row of floating, circular, luminous areas on the visible surface of the otherwise transparent waveguide. In FIG. 10, luminaire 79 has a square configuration, such as commonly found in office recessed lighting, and is provided with strips of LEDs 81 positioned around the entire perimeter edge of the light waveguide 83. The waveguide in this case has a center square light extracting portion 85 for producing a square luminous area set within a perimeter transparent region 87.

FIGS. 11 and 12 show a variation of the square configuration luminaire of FIG. 10. In FIG. 11, the square waveguide luminaire 89 has a planar waveguide 91 with a light-extracting region 93 in the form of a square ring, and in FIG. 12, the luminaire 95 has a waveguide 97 with a light-extracting portion in the form of a circular ring 99, each of which produces a ring-shaped luminous area on its respective waveguide. In FIG. 11, the perimeter region 92 and center region 94 are transparent and non-luminous, as are the perimeter region 98 and center region 100 of the waveguide shown in FIG. 12.

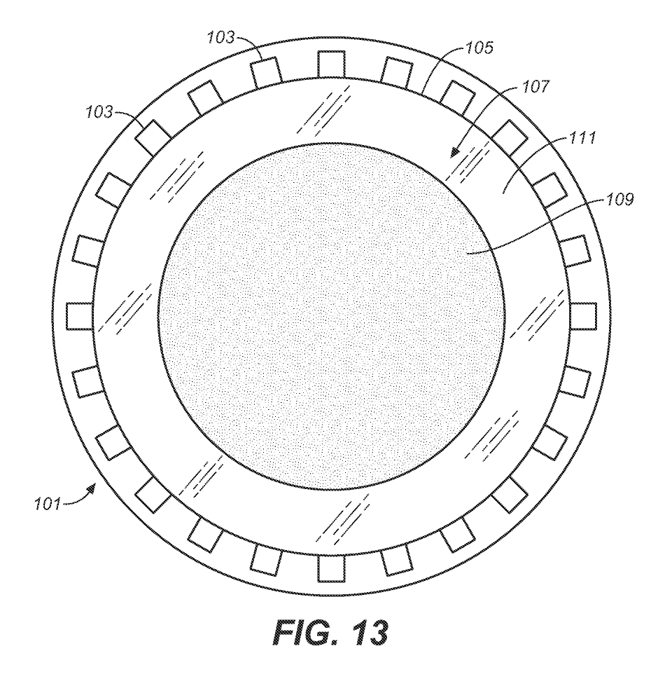

In FIG. 13, a luminaire 101 having a circular configuration is shown. In this configuration, LED light sources 103 are distributed around the circular perimeter edge 105 of a circular light waveguide 107 for injecting light into the waveguide that is piped to the circular and centered light extracting portion 109 of the guide for producing a centered luminous area on the guide that is surrounded by an annular transparent portion 111.

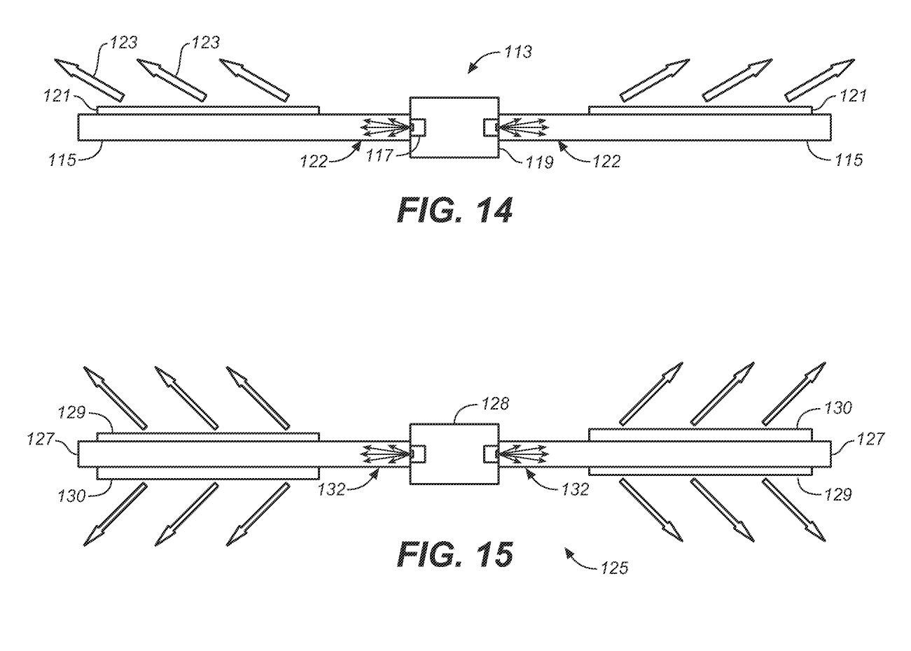

FIGS. 14 and 15 graphically illustrate another variation of a waveguide luminaire in accordance with the invention, wherein the support structure for the light waveguide is located in the center of the waveguide and wherein the light extraction means on the waveguide is provided by a thin light transmitting and shaping diffuser material, such as light shaping diffusers commercially available through Luminit LLC of Torrence, Calif. In FIG. 14, light waveguides 115 of luminaire 113 are fed by LED light sources 117 and are centrally supported by a center support structure graphically illustrated by center block 119. The light shaping diffuser material 121 on the top surface of waveguides 115 extracts light piped down the waveguides 115 in a directional distribution pattern (represented by arrows 123), which is determined by the characteristics of the particular light shaping diffuser material selected by the lighting designer. In FIG. 15, the

In the embodiments shown in FIGS. 14 and 15, luminous areas would be created on the bottom of the waveguides 115, 127 corresponding to the outline of the light shaping diffusers 121 and 129, which are bounded by transparent, non-luminous areas 122, 132 adjacent the diffusers. Thus, a desired light distribution can be created from portions of the waveguide that also produce visible luminous patterns that appear to float relative to their support structure.

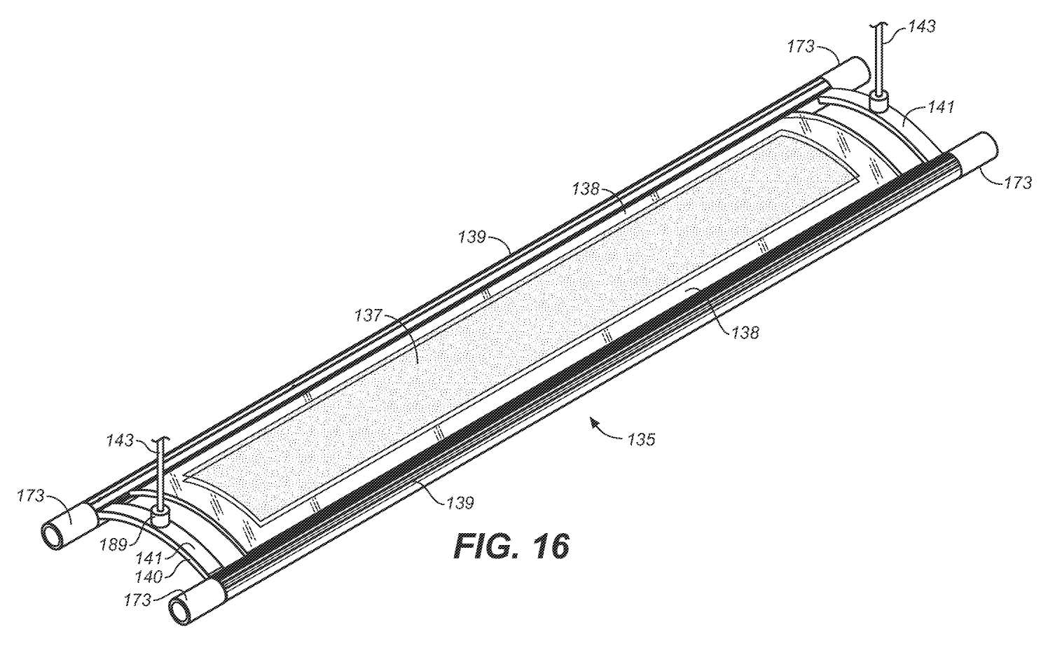

FIGS. 16-18 show yet another embodiment of the invention wherein waveguide luminaire 135 has a light waveguide 137 that lies in a curved plane rather than a flat plane and that has a perimeter edge consisting of long edge portions 138 and shorter curved edge portions 140. In this embodiment, the support structure for the waveguide includes elongated heat dissipating edge support rails 139 and crossbars 141, from which the luminaire can be suspended from an overhead structure, such as by hollow stems 143. The edge support rails, which can have a generally circular cross-sectional shape, can suitably be fabricated of extruded aluminum and provided with a heat dissipating fin structure 145. A longitudinal interior edge retainer slot 147 is provided in each support rail

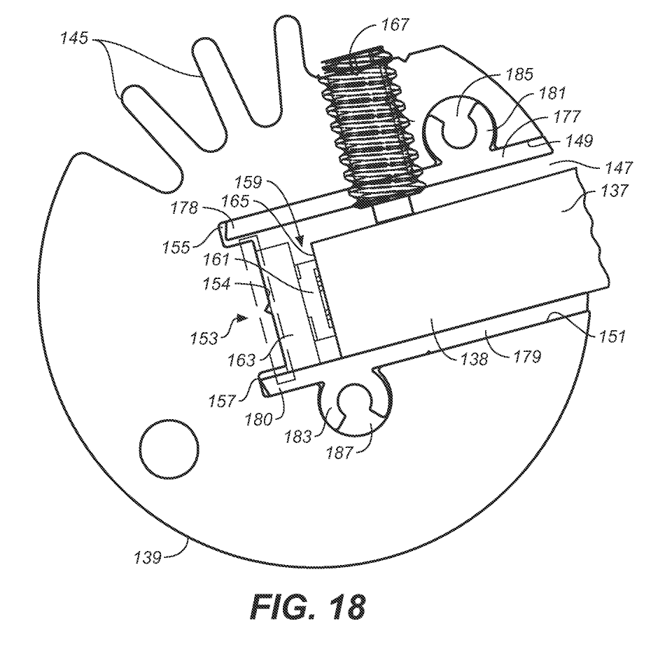

As best seen in FIG. 18, the retainer slot of each support rail has a top wall 149, a bottom wall 151, and a back end 153. The back end of the slot has a raised rear wall 154, which forms longitudinal recesses 155, 157 at the top and bottom of the slot. One or more LED strips 159, which are comprised of LEDs 161 mounted to a backing board 163, can be affixed to the raised rear wall 154 at the back end of the slot by, for example, a suitable thermal adhesive tape. When affixed in this manner, the heat conductive rail 139 will act as a heat sink for the LEDs. (The backing boards of the LED strips are suitably metal to provide heat conductivity between the LEDs and rails.) If more than one LED strip is used to span a length of the long waveguide edge, they can suitably be electrically connected together within the slot by commercially available small profile flexible connectors.

Referring again to FIG. 18, it can be seen that, when the long perimeter edge portion 138 of waveguide 137 is inserted into the support rail's retaining slot 147, the LEDs 161 of the LED strip 159 will face the light feed edge 165 for the waveguide. The guide's light feed edge is preferably positioned in the slot to touch the LEDs so that the light emitted by the LEDs will efficiently couple into the waveguide. As above mentioned, optically bonding the LEDs to the guide's light feed edge 165 can improve this coupling efficiency, but it is not required. Coupling efficiency might also be improved by shaping the long edge portion of the guide as shown in FIG. 5.

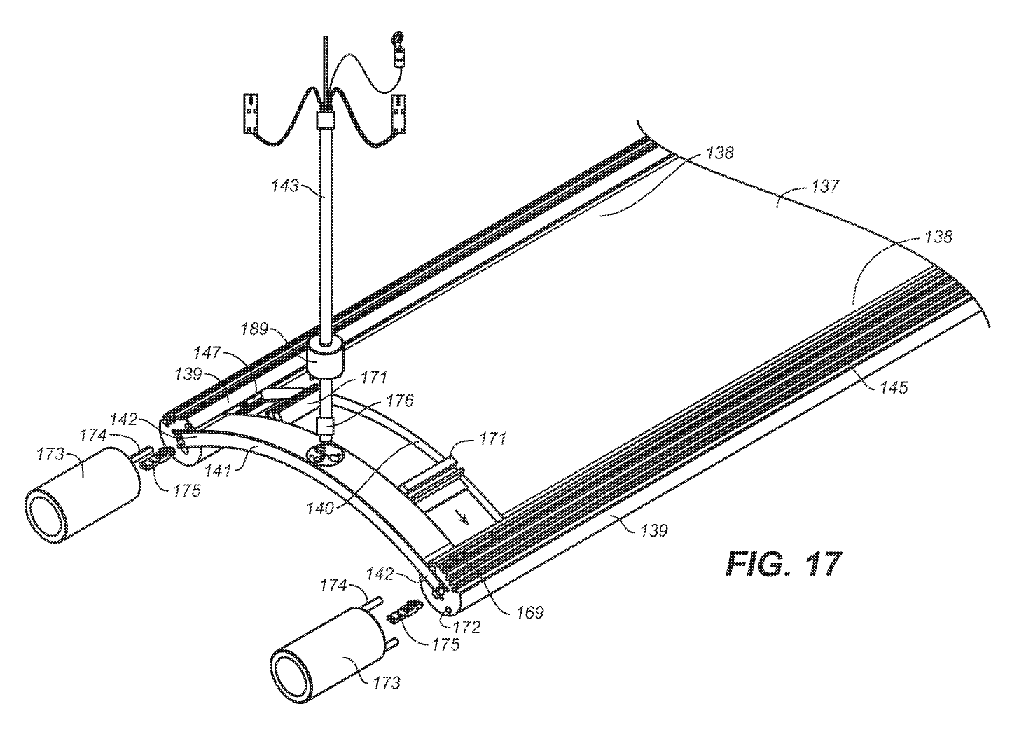

As shown in FIG. 18, after the edge waveguide's long edge portion 138 is inserted into the slot 147 of support rail 139, the waveguide edge can be held in the slot by suitable fastening means such as set screws 167, which can suitably have hard nylon tips. The distal ends 142 of crossbars 141 can similarly be held in the support rail retainer slots by set screws, such as the set screws denoted by the numeral 169 in FIG. 17. This assembly can suitably be done using a jig to align the parts before the set screws are tightened. To produce a finished and more aesthetically pleasing look to the rails, fill plugs 171 can be added to fill the portions of the retaining slot between the waveguide's short perimeter edges 140 and the crossbar ends 142, and complimentary end caps 173 can be attached to the ends of the rails. The end caps can be attached to the ends of the rails by suitable attachment means such as attachment posts 174 sized to fit snugly into post holes 172 in the ends of the rails. They can also have a hollow region (not shown) in which wire connectors, such as denoted in FIG. 17 by the numeral 175, can be tucked. Such wire connectors, such as Motex connectors, can be used for connecting electrical wires threaded through the crossbar 141 to the wire leads of the LED strips. A further wire connector 176 can be used to connect the wiring emerging from wiring openings in the top of the hollow crossbar to the wiring threaded through the hollow stem 143. Finish cap 189 is provided to cover wire connector 176 and its associated wiring.

It is noted that a certain amount of light emitted from the LEDs 161 shown in FIG. 18 will escape from the edge of the waveguide captured by the rail's retaining slot 147. This light can produce internal reflections within the slot that result in unwanted areas of brightness along the long edge of the waveguide where the waveguide enters the slot. To prevent this from occurring, top and bottom wall non-reflective inserts 177, 179 are provided that line the top and bottom walls of the slot. These inserts can suitably be strips of CPVC plastic which is a matte grey. As seen in FIG. 18, these inserts can be held in place by resilient snap members 181, 183 on the back of the inserts, which snap into top and bottom channel openings 185, 187 in the slot's top and bottom walls. The top and bottom inserts are identically shaped and each is suitably dimensioned such that their ends 178, 180 extend into the longitudinal recesses 155, 157 at the back end of the slot. This extension will improve the ability of the inserts to suppress internal reflections that might cause unwanted bright spots along the rails.

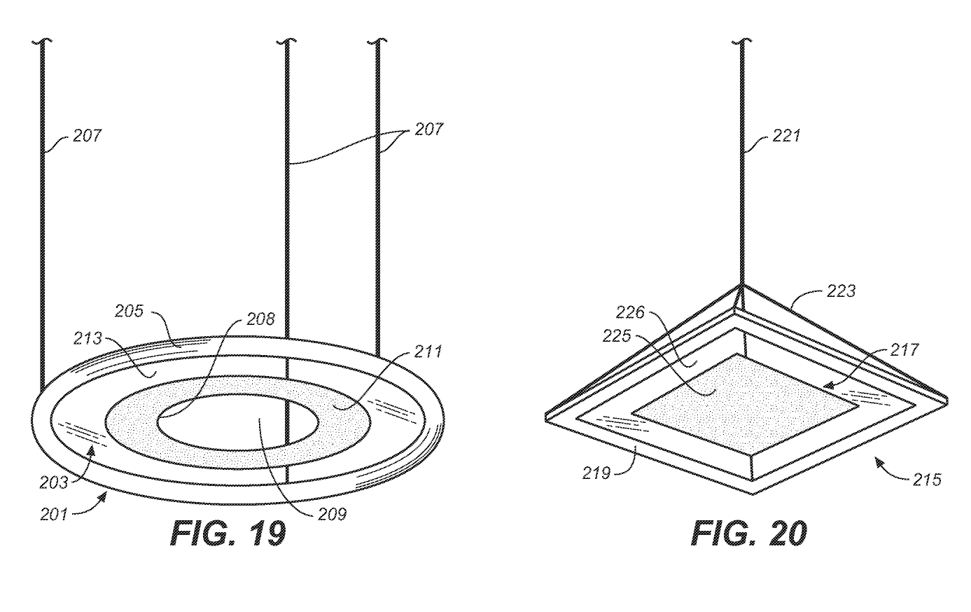

FIGS. 19-23 graphically illustrate further examples of configurations for a waveguide luminaire in accordance with the invention, and particularly suspended luminaires and different support structures therefore. In FIG. 19, the luminaire 201 has a flat circular light waveguide 203 held in a support structure in the form of an aesthetically pleasing circular support rim 205. This luminaire is suspended in a horizontal plane by multiple suspension stems or cables 207 attached to the support rim. The waveguide has a center opening 209, and light extraction from the waveguide occurs within an inner ring portion 211 surrounding the center opening. The inner edge 208 of ring portion 211 can suitably be covered by a reflective material, such as white reflective tape (not shown) to prevent light from being emitted at this edge. The outer diameter of the light extraction ring 211 is separated from the support rim by an outer ring portion 213 of the waveguide where no light extraction occurs and which is transparent. Thus, the visible luminous area on the bottom of the luminaire will give the appearance of a luminous ring floating within an aesthetically pleasing, larger diameter circular rim.

In FIG. 20 the luminaire 215 has a square waveguide 217 held by a support structure in the form of an aesthetically pleasing square support rim 219 suspended in a horizontal plane by a single suspension stem or cable 221 tied to the corners of the support rim by tie cables 223. In this case, light extraction from the waveguide occurs in a square 225 at the center of the waveguide, which is bordered by transparent square ring portion 226 of the guide, giving the appearance of a luminous square floating within an aesthetically pleasing square rim.

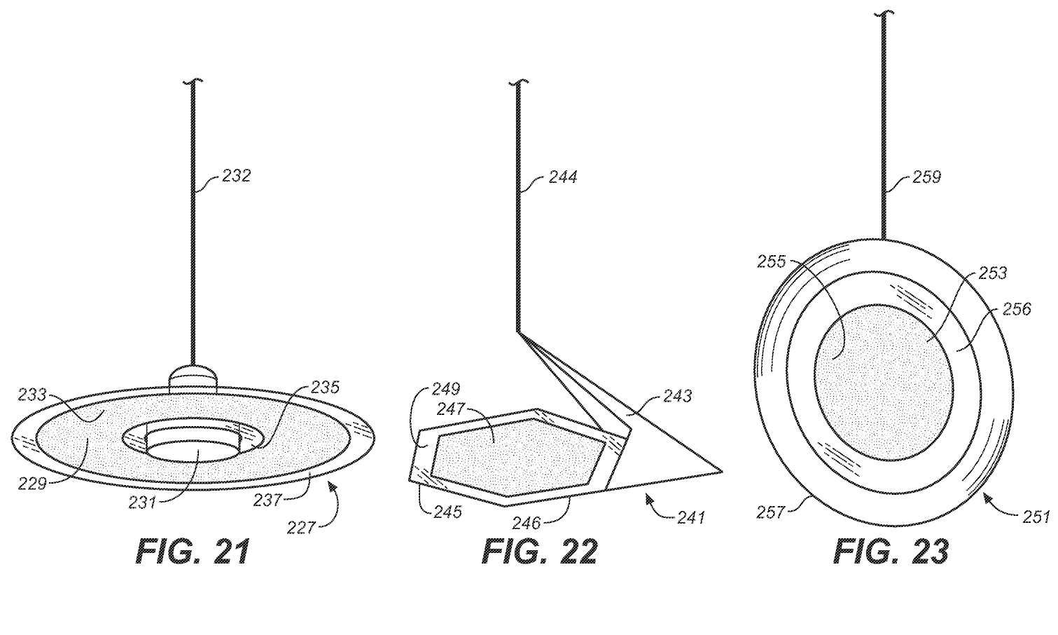

FIG. 21 shows a luminaire 227 wherein a light source for feeding the edges of the luminaire waveguide 229 is contained within a center hub 231 suspended by a single stem or cable 232. The center hub 231, which contains the light source for feeding the waveguide (such as graphically illustrated in FIGS. 14 and 15), supports the waveguide in a horizontal plane. Suitably, the light source will be substantially equally spaced LEDs (also not shown) positioned in the hub to face the inner feed edge (not shown) of the waveguide. As shown, light extraction occurs at an intermediate ring 233 which is bordered on both the inside and outside by transparent non-extracting inner and outer waveguide rings

FIG. 22 shows a luminaire 241 having an aesthetically pleasing support structure in the form of an angled frame 243 that is suspended at an upper tip by a stem or cable 244 and that holds a hexagonal waveguide 245 along only a portion of the guide's perimeter edge 246. In this case, the light extraction occurs within a hexagonally-shaped center portion 247 of the guide bordered by a hexagonal non-extracting portion 249 of the guide that is transparent to give the appearance of a floating hexagonal disc. In this case, light from a light source (not shown) supported by the frame 243 is only injected into a portion of the waveguide's edge.

FIG. 23 shows a variation wherein a light waveguide of luminaire 251 can be supported in a vertical plane rather than a horizontal plane. Here, the circular waveguide 253 having a center light extracting portion 255 and surrounding non-luminous transparent ring 256 is supported within an aesthetically pleasing circular frame 257, which is suspended on end by stem (or cable) 259.

It will be understood that variations of the waveguide luminaire of the invention other than illustrated and described herein are possible. For example, while the light extracting portion of the otherwise transparent waveguide is shown as being completely detached from its surrounding support structure, it is contemplated that a portion of the light extraction area of the waveguide could extend to one or more edges of the support structure so long as areas of transparency without light extraction are provided contiguous to the light extracting regions to produce a sense of visual detachment between the luminous areas on the waveguide and the support structure. In such cases the visible luminous areas of the waveguide would appear to be tethered to the support structure, but not an integral part of the support structure. Light extraction for producing luminous areas of the luminaire's light waveguide contiguous to non-luminous transparent areas can be provided by any means of extracting light from a light waveguide, including the use of diffusers, prisms, microprisms, or a combination of diffusers and a prismatic surface, or by sandblasting the desired portions of the waveguide surface. Still further, a luminaire can be provided having a support structure which supports more than one light waveguide and which has light sources (such as LEDs) for feeding each waveguide. Each light waveguide of the luminaire would have extraction means for producing a visible luminous area on the waveguide that is seemingly detached or partially detached from the support structure so as to produce seemingly floating sources of light in proximity to the support structure. The two or more waveguides could be supported in the same plane or different planes.

It will be further understood that the light waveguides described and illustrated herein could be supported in planes other than those shown in the drawings, including angled planes. For example, the luminaires 113 and 125 shown as lying in a horizontal plane in FIGS. 14 and 15 could be oriented in a vertical plane instead of a horizontal plane. An example of a luminaire in accordance with the invention that is suspended in a vertical plane is shown in FIG. 23.

It is noted that, depending on where light is fed into the luminaire waveguide and how the light extraction means is applied to the waveguide, the exhibited brightness (luminance) of the luminous area or areas on the visible surface of the guide can be uniform or non-uniform. By feeding light into the guide uniformly from both sides of the light extraction means, as shown, for example, in FIG. 7, the luminance across the visible discrete luminous area on the guide surface will be substantially uniform. However, in other configurations, such as where the light waveguide is fed from one side only, as shown in FIG. 22, the luminance across the visible luminous area or areas on the guide surface can be expected to be non-uniform. The uniformity of the visible surface luminance across the light-extracting portion of the guide can be adjusted by varying the light extraction means of the guide over the guide's light-extracting portions in order to vary the amount of light extracted. For example, where the waveguide is fed along one edge, as shown in FIG. 22, the luminance of the hexagonally-shaped center luminous area 247 on the waveguide would be expected to fall off toward the side of the area opposite the support structure 243. Such a fall off in luminance can be compensated for by increasing the amount of light extraction across this center portion of the guide from the side near the support structure to the side furthest away from the support structure. This could be done, for example, by increasing the degree to which the hexagonal center portion of the guide is sandblasted from the near side to the far side.

While the various embodiments of the invention have been described in considerable detail in the foregoing specification and the accompanying drawings, it will be understood that it is not intended that the invention be limited to such detail except as necessitated by the following claims.

I claim:

1. A waveguide luminaire for producing a visible source of light for illuminating a space comprising
at least one transparent light waveguide having a perimeter edge, at least one light feed edge portion along said perimeter edge, and a visible surface;
a support structure for supporting said light waveguide along at least a portion of its perimeter edge,
a light source positioned for introducing light into the at least one light feed edge portion of the perimeter edge of said light waveguide, and
light extracting means provided on said light waveguide for extracting light introduced into the waveguide at the light feed edge portion thereof through the waveguide's visible surface, said light extracting means being provided over only a portion of the light waveguide so as to produce at least one luminous area on the visible surface of said waveguide which appears on only a portion of said visible surface, said light extracting means being positioned on said waveguide such that the luminous area on the visible surface of the waveguide produced the light extracting means is substantially detached from said support structure to give the appearance of a source of light that is substantially detached from said support structure.

2. The luminaire of claim 1 wherein said light extracting means is positioned on said light waveguide such that the luminous area on the visible surface of the waveguide produced the light extracting means is completely detached from said support structure to give the appearance of a source of light that is completely detached from said support structure.

3. The luminaire of claim 1 wherein the light source said light source includes at least one LED.

4. The luminaire of claim 1 wherein said light source includes a plurality of LED's arranged in a row along the at least one light feed edge of said light waveguide

5. The luminaire of claim 1 wherein the light feed edge portion of said waveguide extends around substantially around the entirety of the perimeter edge of said waveguide and wherein said light source includes sources of light distributed along said light feed edge portion.

6. The luminaire of claim 1 wherein said light waveguide lies in a flat plane.

7. The luminaire of claim 1 wherein said light waveguide lies in a curved plane.

8. The luminaire of claim 1 wherein the light source for introducing light into the at least one light feed edge portion of the perimeter edge of said light waveguide is positioned in said support structure, and wherein said support structure is at least in part heat conductive for dissipating heat generated by said light source.

9. The luminaire of claim 1 wherein
said light waveguide has straight perimeter side edges forming a square,
a light feed edge portion is provided long at least one of said perimeter side edges,
said light source includes sources of light positioned along said light feed edge portion for introducing light into said waveguide along at least one perimeter side edge of said waveguide, and
light extracting means are provided on the square waveguide within and not contiguous to the perimeter edges thereof for producing a luminous area on the visible surface of the square waveguide that is detached from said support structure of the luminaire.

10. The luminaire of claim 9 wherein a light feed edge portion is provided along all of said perimeter side edges of said waveguide, and sources of light are positioned along said light feed edge portions for introducing light into said waveguide along each of the perimeter side edges of said waveguide.

11. The luminaire of claim 1 wherein
said light waveguide is a circular waveguide having a circular perimeter edge,
a light feed edge portion is provided long at least a portion of said circular perimeter edge,
said light source includes sources of light positioned along said light feed edge portion for introducing light into said waveguide along at least a portion of the circular perimeter edge of said waveguide, and
light extracting means are provided on the circular waveguide within and not contiguous to the perimeter edge thereof for producing a luminous area on the visible surface of the circular waveguide that is detached from said support structure of the luminaire.

12. The luminaire of claim 11 wherein said light feed edge portion extends around substantially the entire circular perimeter edge of said waveguide, and sources of light are positioned along said light feed edge portion for introducing light into said waveguide around of the circular perimeter edge of said waveguide.

13. The luminaire of claim 1 wherein
said light waveguide has a substantially rectangular shape defined by long perimeter edges and short perimeter edges,
the light feed edge portions of said light waveguide are on the long perimeter edges of said waveguide,
the light extracting means is provided on said light waveguide between the long perimeter edges of said light waveguide, and
said light source is comprised of sources of light distributed along at least one of the long perimeter edges of said waveguide for introducing light into the light feed edge portion of said long perimeter edge that is extracted from the waveguide by the light extracting means between said long perimeter edges.

14. The luminaire of claim 13 wherein said light source is comprised of sources of light distributed along both of the long perimeter edges of said waveguide for introducing light into the light feed edge portion of both long perimeter edge that is extracted from the waveguide by the light extracting means between said long perimeter edges.

15. The luminaire of claim 14 wherein said waveguide lies in a flat plane.

16. The luminaire of claim 1 wherein said light waveguide lies in a plane that is curved in the direction of the short edge of said waveguide.
